(19) United States
(12) Patent Application Publication
(10) Pub. No.: US 2025/0046180 A1
(43) Pub. Date: Feb. 6, 2025

(54) ASSISTANCE CONTROL APPARATUS, ASSISTANCE CONTROL METHOD, AND COMPUTER-READABLE STORAGE MEDIUM

(71) Applicant: HONDA MOTOR CO.,LTD., Tokyo (JP)

(72) Inventors: Yuta SAKAGAWA, Saitama (JP); Takahiro KUREHASHI, Saitama (JP)

(21) Appl. No.: 18/786,445

(22) Filed: Jul. 27, 2024

(30) Foreign Application Priority Data
Jul. 31, 2023 (JP) 2023-124461

(51) Int. Cl. G08G 1/005; G01S 19/42; G08G 1/01

(52) U.S. Cl. CPC G08G 1/005; G08G 1/012; G08G 1/0141; G01S 19/42

(57) ABSTRACT

An assistance control apparatus comprises an acquisition unit which acquires location information of a user terminal, a crossing area identification unit which identifies, based on current location information of the user terminal, a destination of a user associated with the user terminal, a predicted crossing area, and an assistance control unit which performs control related to assistance for a traffic participant when the user terminal is located within a predetermined range including the crossing area. An assistance control method comprises acquiring location information of a user terminal, identifying, based on current location information of the user terminal and a destination of a user associated with the user terminal, a predicted crossing area, and performing control related to assistance for a traffic participant, when the user terminal is located within a predetermined range including the crossing area.

The contents of the following patent applications are incorporated herein by reference:
NO. 2023-124461 filed in JP on Jul. 31, 2023

### BACKGROUND

### 1. Technical Field

The present invention relates to an assistance control apparatus, an assistance control method, and a computer-readable storage medium.

### 2. Related Art

In recent years, efforts have been intensified to provide access to a sustainable transportation system with consideration given to even vulnerable people among other traffic participants. To achieve this, research and development has been focused on to further improve traffic safety and convenience through research and development regarding a preventive safety technique. Patent documents 1-4 describe techniques related to road crossing and running-out onto the road of pedestrians.

### PRIOR ART DOCUMENTS

### Patent Documents

Patent document 1: Japanese Patent Application Publication No. 2019-28916
Patent document 2: Japanese Patent Application Publication No. 2009-14440
Patent document 3: Japanese Patent Application Publication No. 2002-42294
Patent document 4: Japanese Patent Application Publication No. 2019-32174

### BRIEF DESCRIPTION OF THE DRAWINGS

FIG. 1 schematically illustrates a usage scene of a assistance system 10.

FIG. 2 illustrates a functional configuration of an assistance apparatus 60.

FIG. 3 illustrates an example data structure of location history information of a user terminal 82.

FIG. 4 illustrates an example data structure of crossing point information.

FIG. 5 illustrates an example data structure of frequent crossing point information.

FIG. 6 illustrates an example execution sequence of process that is performed at the user terminal 82, the assistance apparatus 60, and an in-vehicle processing apparatus 40 included in a vehicle 20.

FIG. 7 illustrates an example flowchart related to processing according to an assistance control method performed at an assistance control apparatus 200.

FIG. 8 illustrates an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

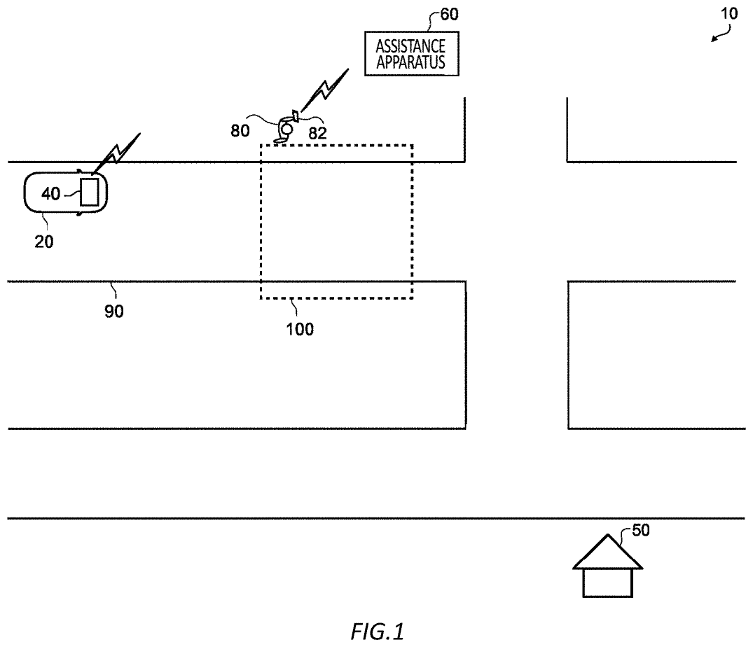

FIG. 1 schematically illustrates a usage scene of a assistance system 10. The assistance system 10 includes a vehicle 20, a user terminal 82, and an assistance apparatus 60.

The vehicle 20 includes an in-vehicle processing apparatus 40. The user terminal 82 is a terminal possessed by a user 80. In the present embodiment, the user 80 is a pedestrian.

The vehicle 20 is a vehicle that is traveling on a road 90. The vehicle 20 is an example of a mobile object. The in-vehicle processing apparatus 40 includes a functionality to communicate with the outside by using mobile communication. The in-vehicle processing apparatus 40 is configured to include sensors such as a location sensor including a global navigation satellite system (GNSS) receiver, a speed sensor such as a vehicle speed sensor, a distance measuring sensor that measures the distance from the vehicle 20 to surrounding objects. The in-vehicle processing apparatus 40 includes a functionality to process the information acquired by various types of sensor included in the in-vehicle processing apparatus 40, and a functionality to communicate with the assistance apparatus 60. The in-vehicle processing apparatus 40 provides an advanced driving assistance system (ADAS) functionality included in the vehicle 20.

The user terminal 82 is a portable terminal such as a smartphone, for example. The user terminal 82 is an example of a mobile object. The user terminal 82 periodically transmits, to the assistance apparatus 60, current location information of the user terminal 82 detected by the location sensor including the GNSS receiver.

The assistance apparatus 60 receives, through mobile communication, information transmitted from the in-vehicle processing apparatus 40 and the user terminal 82. The assistance apparatus 60 may receive, through mobile communication and communication lines such as the Internet and dedicated lines, information transmitted from the in-vehicle processing apparatus 40 and the user terminal 82. The assistance apparatus 60 perform traffic assistance for a traffic participant, based on the information received from the in-vehicle processing apparatus 40 and the user terminal 82.

In the present embodiment, it may be assumed that the user 80 exists within a predetermined range from the location of the user terminal 82. The assistance apparatus 60 stores major destinations of the user 80 from a history of the location information previously received from the user terminal 82. The assistance apparatus 60 estimates the current destination of the user 80 based on the current location of the user terminal 82 and the major destinations of the user 80.

For example, from a moving history estimated from the history of previous location information of the user terminal 82, since the user 80 frequently returned home 50 in the evening, the assistance apparatus 60 determines that the destination of the user 80 is home 50 when the location of the user terminal 82 is within a predetermined range from home 50 in the evening.

The assistance apparatus 60 identifies a crossing area 100 where the user 80 is likely to cross a road 90, on a walking path from the current location of the user terminal 82 to the estimated destination. The assistance apparatus 60 may identify the crossing area 100 from a predicted walking path from the current location of the user terminal 82 to home 50. The assistance apparatus 60 may identify a shortest walking path from the current location of the user terminal 82 to home 50, and identify, as the crossing area 100, an area including a location where crossing of the road 90 is necessary in order to move on the identified walking path. The assistance apparatus 60 may predict a walking path, among expected walking paths from the current location of the user terminal 82 to home 50, having the least number of crossing of the road 90, and identify the crossing area 100 based on the predicted walking path. The assistance apparatus 60 may identify the crossing area 100 based on the history of previous location information of the user terminal 82. The assistance apparatus 60 may identify the crossing area 100 based on the history of previous location information of many users.

When the current location of the user terminal 82 is within a predetermined range including the crossing area 100, the assistance apparatus 60 transmits assistance information to instruct an in-vehicle processing apparatus 40 to output a warning that a pedestrian exists to the in-vehicle processing apparatus 40 of the vehicle 20 that is traveling around the user terminal 82. In this manner, assistance can be performed at the crossing area 100 where the user 80 is likely to run out onto the road 90, which allows unnecessary assistance to be suppressed from being performed frequently, as well as allows traffic assistance related to crossing of the road 90 to be appropriately performed.

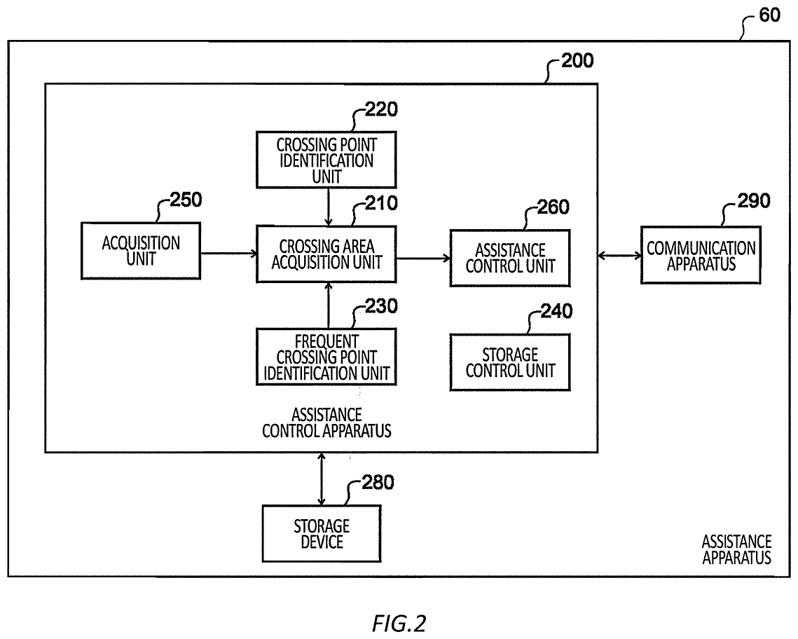

FIG. 2 illustrates a functional configuration of an assistance apparatus 60. The assistance apparatus 60 includes an assistance control apparatus 200, a communication apparatus 290, and a storage device 280.

The communication apparatus 290 is responsible for communication between each of the in-vehicle processing apparatus 40 and the user terminal 82, and the assistance apparatus 60, based on control by the assistance control apparatus 200. The assistance control apparatus 200 is achieved by being provided with a circuitry such as an arithmetic processing apparatus including a processor, for example. The assistance control apparatus 200 may be achieved by a microcomputer provided with a CPU, a ROM, a RAM, an I/O, a bus, and the like. The storage device 280 is achieved by being provided with a non-volatile storage medium. The assistance control apparatus 200 performs processing by using the information stored in the storage device 280. The storage device 280 may store map information. The map information stored in the storage device 280 may be used by the assistance control apparatus 200.

The assistance control apparatus 200 includes an acquisition unit 250, a crossing area identification unit 210, an assistance control unit 260, a crossing point identification unit 220, a frequent crossing point identification unit 230, and a storage control unit 240. Note that, a form in which the assistance apparatus 60 does not have some of the functionalities in the functional configuration illustrated in FIG. 2 may be adopted.

The acquisition unit 250 acquires location information of the user terminal 82. The crossing area identification unit 210 identifies a crossing area, which is an area in which the user 80 is predicted to cross the road 90, based on the current location information of the user terminal 82 and the destination of the user 80 associated with the user terminal 82. The assistance control unit 260 performs control related to assistance for a traffic participant when the user terminal 82 is located within a predetermined range including the crossing area.

The crossing point identification unit 220 identifies a crossing point, which is where the user 80 has previously crossed the road, based on location information history of the user terminal 82. The crossing area identification unit 210 may identify the crossing area based on the current location information of the user terminal 82, the destination of the user 80, and the crossing point.

The storage control unit 240 performs control to store the crossing point in association with the destination of the user 80. The crossing area identification unit 210 may identify the crossing area based on the current location information of the user terminal 82 and the crossing point that is stored in association with the destination of the user 80.

The storage control unit 240 may perform control to store the crossing point in association with the destination of the user 80 and the time zone. The crossing area identification unit 210 may identify the crossing area based on the current location information of the user terminal 82 and the crossing point that is stored in association with the destination of the user and the current time zone.

The frequent crossing point identification unit 230 identifies a frequent crossing point, which is where a plurality of users associated with a plurality of user terminals 82 frequently cross the road, based on the location information history of the plurality of user terminals 82. The crossing area identification unit 210 may identify the crossing area based on the current location information of the user terminal 82, the destination of the user 80, and the frequent crossing point.

The storage control unit 240 may perform control to store the frequent crossing point in association with destinations of the plurality of users. The crossing area identification unit 210 may identify the crossing area based on the current location information of the user terminal 82 and the frequent crossing point that is stored in association with the destination of the user 80.

The storage control unit 240 may perform control to store the frequent crossing point in association with the destinations of the plurality of users and the time zone. The crossing area identification unit 210 may identify the crossing area based on the current location information of the user terminal 82 and the frequent crossing point that is stored in association with the destination of the user 80 and the current time zone.

The assistance control unit 260 may perform control to cause a warning to be output to a vehicle 20 that is approaching a user, when the user terminal 82 is located within a predetermined range including the crossing area.

The assistance control unit 260 may perform control to cause a warning to be output to the user 80, when the user terminal 82 is located within a predetermined range including the crossing area and there is a vehicle 20 that is approaching the user 80.

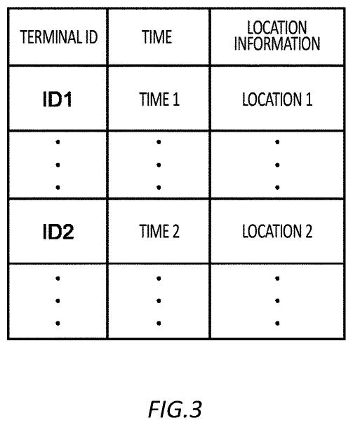

FIG. 3 illustrates an example data structure of location history information of the user terminal 82. The location history information is generated based on the location information acquired from the user terminal 82 and stored in the storage device 280.

The location history information includes an ID, time, and location information as data items.

The ID indicates identification information of the user terminal 82. The time indicates the time at which the location information was acquired. The location information indicates location information of the user terminal 82.

The location information may be latitude/longitude information of the location of the user terminal 82, for example.

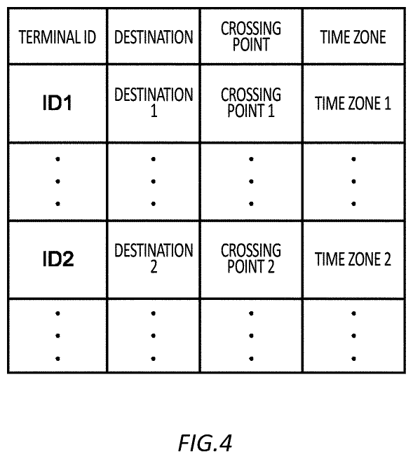

FIG. 4 illustrates an example data structure of crossing point information. The crossing point information is stored in the storage device 280. The crossing point information includes a terminal ID, a destination, a crossing point, and a time zone as data items.

The terminal ID indicates identification information of the user terminal 82. The destination of the user 80 identified by terminal ID is indicated. The destination of the user 80 is identified based on the location information history of the user terminal 82. The destination may be latitude/longitude information indicating the location of the destination.

The crossing point indicates a point where the user 80 is determined to have crossed the road 90. The crossing point may be latitude/longitude information of the point where the user 80 is determined to have crossed the road 90. The crossing point is identified based on the location information history of the user terminal 82.

The time zone indicates the time zone in which the user 80 crossed the road 90 at the crossing point. The time zone is identified based on the location information history of the user terminal 82.

The crossing point identification unit 220 identifies a moving path of the user terminal 82 for each piece of identification information of the user terminal 82 by referring to the location history information, and based on the identified moving path and map information, identifies the crossing point on the road 90, as well as identifies the time zone in which the road 90 was crossed at the crossing point. The storage control unit 240 stores, in the storage device 280, the crossing point and the time zone identified by the crossing point identification unit 220 and the destination identified from the moving path in association with the identification information of the user terminal 82, as the crossing point information.

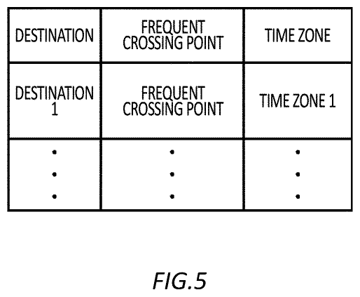

FIG. 5 illustrates an example data structure of frequent crossing point information. The frequent crossing point information is stored in the storage device 280. The frequent crossing point information includes the destination, the frequent crossing point, and the time zone as data items.

The destination indicates the destinations of many users. The destination may be latitude/longitude information indicating the location of the destination. The frequent crossing point indicates the point where many users crossed the road. The frequent crossing point may be latitude/longitude information of the point where crossing frequently occurred. The time zone indicates the time zone in which the crossing at said frequent crossing point occurred.

The frequent crossing point information is generated by extracting a frequent combination among combinations of the destination identified from the moving history information of many user terminals, the crossing point and the time zone, and the crossing point. For example, the crossing point identification unit 220 identifies the moving path of the user terminal 82 for each piece of identification information of the user terminal 82 by referring to the location history information, as described above, and identifies the crossing point of the road 90 as well as identifies the time zone in which the road 90 was crossed at said crossing point, based on the identified moving path and the map information. The storage control unit 240 aggregates the crossing point and the time zone identified by the crossing point identification unit 220 and the destination identified from the moving path to extract the combination of a frequent destination, crossing point, and time zone, and stores the extracted combination of the destination, the crossing point, and the time zone as the frequent crossing point information in the storage device 280.

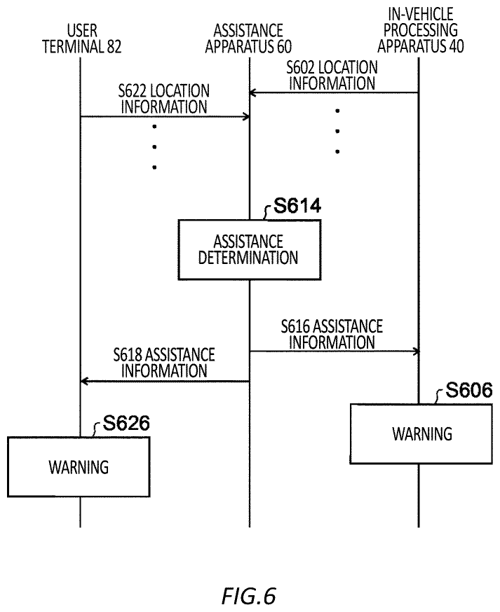

FIG. 6 illustrates an example execution sequence of processing performed at the user terminal 82, the assistance apparatus 60, and an in-vehicle processing apparatus 40 included in the vehicle 20.

At S602, the in-vehicle processing apparatus 40 transmits location information of the vehicle 20 based on a signal received from a GNSS satellite to the assistance apparatus 60. Transmission of the location information from the in-vehicle processing apparatus 40 to the assistance apparatus 60 is performed periodically.

At S622, the user terminal 82 transmits the location information indicating a current location of the user terminal 82 based on the signal received from the GNSS satellite to the assistance apparatus 60 together with the identification information of the user terminal 82. The location information and the identification information are periodically transmitted from the user terminal 82 to the assistance apparatus 60.

At S614, the assistance control unit 260 of the assistance apparatus 60 determines whether assistance for the vehicle 20 and the user terminal 82, which are traffic participants, is to be performed. For example, the assistance control unit 260 identifies the destination of the user 80 from the location information of the user terminal 82 acquired from the user terminal 82, and identifies a crossing area 100 where the user 80 is likely to cross the road 90 on a walking path to the identified destination. When the current location of the user terminal 82 is within a predetermined range including the crossing area 100 and it is determined that the user terminal 82 and the vehicle 20 are to approach each other within a predetermined time, the assistance control unit 260 determines to perform assistance for the vehicle 20 and the user terminal 82.

When it is determined that assistance is to be performed, at S616, the assistance control unit 260 transmits, to the in-vehicle processing apparatus 40, assistance information to instruct the in-vehicle processing apparatus 40 to output a warning, by controlling the communication apparatus 290. Further, at S618, the assistance control unit 260 transmits, to the user terminal 82, assistance information to instruct the user terminal 82 to output a warning, by controlling the communication apparatus 290.

Upon receiving the assistance information from the assistance apparatus 60, at S606, the in-vehicle processing apparatus 40 notifies the occupant of the vehicle 20 to be careful of running-out of pedestrians to the road 90, by means of an HMI (Human Machine Interface) functionality included in the in-vehicle processing apparatus 40 in accordance with the assistance information. The in-vehicle processing apparatus 40 may notify the occupant of the vehicle 20 to be careful of running-out of pedestrians on the road 90, through sound and display onto a display apparatus included in the vehicle 20b.

Upon receiving the assistance information from the assistance apparatus 60, at S626, the user terminal 82 notifies the user 80 that there is a vehicle that is approaching the user 80 by means of the HMI functionality of the user terminal 82. The user terminal 82 may notify the user 80 that there is a vehicle that is approaching the user 80 by means of sound.

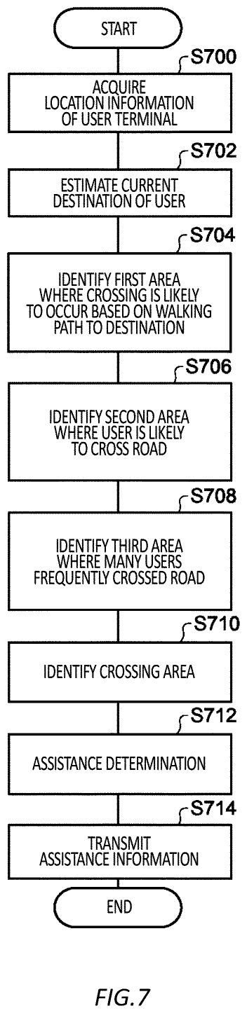

FIG. 7 illustrates an example flowchart related to processing according to an assistance control method performed at an assistance control apparatus 200.

At S700, the acquisition unit 250 acquires the location information of the user terminal 82. At S702, the crossing area identification unit 210 estimates the destination of the user 80. For example, the crossing area identification unit 210 refers to the location history information, for example, and extracts location information associated with the identification information of the user terminal 82. The crossing area identification unit 210 identifies the destination of the moving path at the time zone including the current time in the past, based on the extracted location and the history of time. The crossing area identification unit 210 estimates, as the current destination of the user 80, the destination that is within a predetermined range from the current location, among the identified destinations in the moving path.

At S704, the crossing area identification unit 210 identifies, from the destination estimated at S702 and the map information, the expected walking path from the current location of the user terminal 82 to the destination, and identifies a first area where crossing of the road 90 is likely to occur, based on the identified walking path. The first area is an area where crossing is likely to occur as the walking path, for example. For example, the crossing area identification unit 210 may identify the shortest walking path from the current location of the user terminal 82 to the destination, identify a location where crossing of the road 90 is necessary in order to move on the identified walking path, and identify, as the first area, an area including the identified location. The crossing area identification unit 210 may identify a walking path, among a plurality of walking paths from the current location of the user terminal 82 to the destination, having the least number of crossing of the road 90, identify the location where crossing of the road 90 is necessary in order to move on the identified walking path, and identify, as the first area, an area including the identified location.

At S706, the crossing area identification unit 210 identifies a second area where the user 80 is likely to cross the road. For example, the crossing point identification unit 220 identifies a crossing point associated with the identification information of the user terminal 82, the destination identified at S702, and the current time zone by referring to the crossing point information indicated in FIG. 4. The crossing area identification unit 210 may identify, as the second area, an area including the crossing point identified by the crossing point identification unit 220.

At S708, the crossing area identification unit 210 identifies a third area where many users frequently crossed the road 90. The frequent crossing point identification unit 230 identifies the frequent crossing point associated with the destination identified at S702 and the current time zone, by referring to the frequent crossing point information indicated in FIG. 5. The crossing area identification unit 210 may identify, as the third area, an area including the frequent crossing point identified by the frequent crossing point identification unit 230.

At S710, the crossing area identification unit 210 identifies the crossing area. For example, the crossing area identification unit 210 identifies, as the crossing area, an area including at least one of the first area identified at S704, the second area identified at S706, and the third area identified at S708. The crossing area identification unit 210 may identify, as the crossing area, an area at least including any two of the first area, the second area, and the third area. The crossing area identification unit 210 may identify, as the crossing area, an area at least including all of the first area, the second area, and the third area.

At S712, the assistance control unit 260 determines whether assistance for a traffic participant is to be performed. For example, when the current location of the user terminal 82 is within a predetermined range including the crossing area identified at S710 and it is determined that the user terminal 82 and the vehicle 20 are to approach each other within a predetermined time, the assistance control unit 260 determines to perform assistance for the vehicle 20 and the user terminal 82. For example, the assistance control unit 260 may predict a future location of the vehicle 20 and a future location of the other user terminal 82 within the predetermined time from the current time, and when it is predicted that the vehicle 20 and the other user terminal 82 are to approach each other, based on the predicted future location of the vehicle 20 and the future location of the user terminal 82, determine that the user terminal 82 and the vehicle 20 are to approach each other within the predetermined time.

At S714, the assistance control unit 260 transmits the assistance information to the vehicle 20 and/or the user terminal 82 according to the determination at S712.

According to the assistance system 10 described above, assistance for a traffic participant can be performed when the user 80 exists near a crossing area where the user 80 is likely to run out onto the road 90. In this manner, unnecessary assistance can be prevented from being frequently performed, as well as traffic assistance related to crossing of the road can be adequately performed.

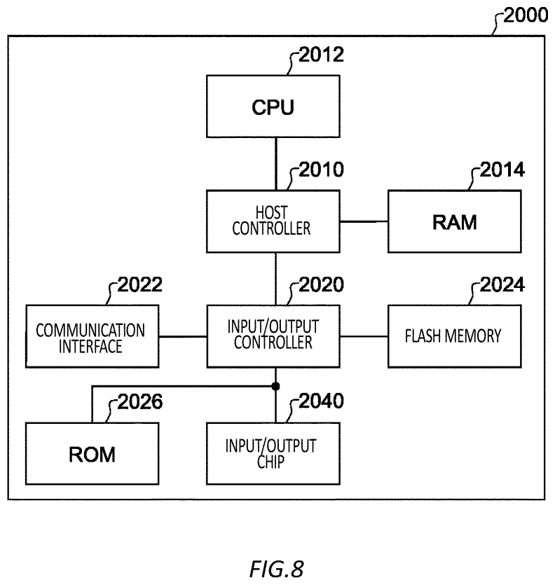

FIG. 8 illustrates an example of a computer 2000 where a plurality of embodiments of the present invention may be entirely or partially embodied. A program installed in the computer 2000 can cause the computer 2000 to function as an apparatus such as the assistance apparatus 60 according to the embodiments or each unit of the apparatus, to perform an operation associated with the apparatus or each unit of the apparatus, and/or to perform a process or a step of the process according to the embodiments. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 are examples of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be configured by achieving operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

Programs that are installed in the computer 2000 and causes the computer 2000 to function as the assistance apparatus 60 may act on the CPU 2012 or the like to cause the computer 2000 to respectively function as each unit (for example, the assistance control apparatus 200 or the like) of the assistance apparatus 60. When read by the computer 2000, the information processings written in these programs function to implement each unit of the assistance apparatus 60 as a specific means where software and various hardware resources as described above. These specific means implement operations or processing of information according to the intended use of the computer 2000 in the present embodiment, and the assistance apparatus 60 is thereby constructed to be specific for the intended use.

Various embodiments have been described with reference to the block diagrams and the like. In the block diagrams, each block may represent (1) a step of a process in which an operation is executed, or (2) each unit of the apparatus having a role in executing the operation. A specific step and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: assistance system,
20: vehicle,
40: in-vehicle processing apparatus,
60: assistance apparatus,
80: user,
82: user terminal,
90: road,
100: crossing area,
200: assistance control apparatus,
210: crossing area identification unit,
220: crossing point identification unit,
230: frequent crossing point identification unit,
240: storage control unit,
250: acquisition unit,
260: assistance control unit,
280: storage device,
290: communication apparatus,
2000: computer,
2010: host controller,
2012: CPU,
2014: RAM,
2020: input/output controller,
2022: communication interface,
2024: flash memory,
2026: ROM,
2040: input/output chip.

What is claimed is:

1. An assistance control apparatus comprising:
an acquisition unit which acquires location information of a user terminal;
a crossing area identification unit which identifies, based on current location information of the user terminal and a destination of a user associated with the user terminal, a crossing area, which is an area where the user is predicted to cross a road; and
an assistance control unit which performs control related to assistance for a traffic participant when the user terminal is located within a predetermined range including the crossing area.

2. The assistance control apparatus according to claim 1, further comprising:
a crossing point identification unit which identifies a crossing point at which the user previously crossed a road, based on location information history of the user terminal, wherein
the crossing area identification unit identifies the crossing area based on the current location information of the user terminal, the destination of the user, and the crossing point.

3. The assistance control apparatus according to claim 2, further comprising a storage control unit which performs control to store the crossing point in association with the destination of the user, wherein
the crossing area identification unit identifies the crossing area based on the current location information of the user terminal and the crossing point that is stored in association with the destination of the user.

4. The assistance control apparatus according to claim 3, wherein
the storage control unit performs control to store the crossing point in association with the destination of the user and time zone, and
the crossing area identification unit identifies the crossing area based on the current location information the of the user terminal and the crossing point that is stored in association with the destination of the user and current time zone.

5. The assistance control apparatus according to claim 1, further comprising:
a frequent crossing point identification unit which identifies, based on location information history of a plurality of user terminals, a frequent crossing point, which is a point where a plurality of users associated with the plurality of user terminals frequently cross a road, wherein
the crossing area identification unit identifies the crossing area based on the current location information of the user terminal, the destination of the user, and the frequent crossing point.

6. The assistance control apparatus according to claim 5 comprising:
a storage control unit which performs control to store the frequent crossing point in association with a destination of the plurality of users, wherein
the crossing area identification unit identifies the crossing area based on current location information of the user terminal, and the frequent crossing point that is stored in association with the destination of the user.

7. The assistance control apparatus according to claim 6, wherein
the storage control unit performs control to store the frequent crossing point in association with the plurality of users' destination and time zone, and
the crossing area identification unit identifies the crossing area based on the current location information of the user terminal, and the frequent crossing point that is stored in association with the users' destination and current time zone.

8. The assistance control apparatus according to claim 1, wherein
when the user terminal is located within the predetermined range including the crossing area, the assistance control unit performs control to cause a mobile object approaching the user to output a warning.

9. The assistance control apparatus according to claim 8, wherein
the mobile object is a vehicle.

10. The assistance control apparatus according to claim 1, wherein
when the user terminal is located within the predetermined range including the crossing area and a mobile object approaching the user exists, the assistance control unit performs control to cause a warning to be output to the user.

11. The assistance control apparatus according to claim 2, further comprising:
a frequent crossing point identification unit which identifies, based on location information history of a plurality of user terminals, a frequent crossing point, which is a point where a plurality of users associated with the plurality of user terminals frequently cross a road, wherein
the crossing area identification unit identifies the crossing area based on current location information of the user terminal, the user's destination, and the frequent crossing point.

12. The assistance control apparatus according to claim 3, further comprising:
a frequent crossing point identification unit which identifies, based on location information history of a plurality of user terminals, a frequent crossing point, which is a point where a plurality of users associated with the plurality of user terminals frequently cross a road, wherein
the crossing area identification unit identifies the crossing area based on current location information of the user terminal, the user's destination, and the frequent crossing point.

13. The assistance control apparatus according to claim 4, further comprising:
a frequent crossing point identification unit which identifies, based on location information history of a plurality of user terminals, a frequent crossing point, which is a point where a plurality of users associated with the plurality of user terminals frequently cross a road, wherein
the crossing area identification unit identifies the crossing area based on current location information of the user terminal, the user's destination, and the frequent crossing point.

14. The assistance control apparatus according to claim 11 comprising:
a storage control unit which performs control to store the frequent crossing point in association with the plurality of users' destination, wherein
the crossing area identification unit identifies the crossing area based on current location information of the user terminal, and the frequent crossing point that is stored in association with the user's destination.

15. The assistance control apparatus according to claim 14, wherein
the storage control unit performs control to store the frequent crossing point in association with the plurality of users' destination and time zone, and
the crossing area identification unit identifies the crossing area based on current location information of the user terminal, and the frequent crossing point that is stored in association with the users' destination and current time zone.

16. The assistance control apparatus according to claim 2, wherein
when the user terminal is located within a predetermined range including the crossing area, the assistance control unit performs control to cause a warning to be output to a mobile object approaching the user.

17. The assistance control apparatus according to claim 3, wherein
when the user terminal is located within a predetermined range including the crossing area, the assistance control unit performs control to cause a warning to be output to a mobile object approaching the user.

18. The assistance control apparatus according to claim 4, wherein
when the user terminal is located within a predetermined range including the crossing area, the assistance control unit performs control to cause a warning to be output to a mobile object approaching the user.

19. An assistance control method comprising:
acquiring location information of a user terminal;
identifying, based on current location information of the user terminal and a destination of a user associated with the user terminal, a crossing area, which is an area where the user is predicted to cross a road; and
performing control related to assistance for a traffic participant, when the user terminal is located within a predetermined range including the crossing area.

20. A non-transitory computer-readable storage medium having stored thereon a program, wherein the program causes a computer to function as:
an acquisition unit which acquires location information of a user terminal;
a crossing area identification unit which identifies, based on current location information of the user terminal and a destination of a user associated with the user terminal, a crossing area, which is an area where the user is predicted to cross a road; and
an assistance control unit which performs control related to assistance for a traffic participant, when the user terminal is located within a predetermined range including the crossing area.
